(19) United States
(12) Patent Application Publication
(10) Pub. No.: US 2015/0296821 A1
(43) Pub. Date: Oct. 22, 2015

(54) Fermented Dairy Product Comprising Microcapsules And Process For Preparing The Same

(71) Applicants: COMPAGNIE GERVAIS DANONE, Paris (FR); DANONE S.A., Barcelona (ES)

(72) Inventors: Cyril Colin, Chatenay-Malabry (FR); Carolina Gasset-Pinon, Barcelona (ES); Eric Rodriguez, Egly (FR)

(21) Appl. No.: 14/391,877

(22) PCT Filed: Apr. 12, 2012
(86) PCT No.: PCT/IB2012/000839

§ 371 Date: Jun. 5, 2015

(51) Int. Cl. A23C 9/13; A23C 9/133; A23C 9/123

(52) U.S. Cl. CPC A23C 9/1322; A23C 9/1234; A23C 9/1238; A23C 9/133; A23Y 2220/17; A23Y 2240/75

(57) ABSTRACT

The invention concerns a fermented dairy product including microcapsules of oxidizable active, and a fermented milk composition.

The present invention relates to the field of fermented dairy product and to its process of preparation. In particular, the present invention relates to a fermented dairy product comprising microcapsules of oxidizable active.

Products such as dairy fermented products are well known. They typically comprise milk or milk components (including water), fermented by lactic acid bacteria. Such products are available in various forms, including “yogurts” and “fermented milk products”. Fermented milk products of the yoghurt type are obtained by fermentation of the milk with a combination of strains of lactic bacteria Streptococcus thermophilus and Lactobacillus bulgaricus. These products are available with various nutritional profiles depending typically on the amount of fat, protein, and carbohydrates, and added sugar, in the composition. The presence of lactic acid bacteria, and the fermentation typically allow proteins of milk or milk components to coagulate and thus to provide texture. The viscosity can then be adjusted by stirring. Moreover, the lactic acid bacteria have well known to have beneficial effects on health. It has been shown that some lactic bacteria, in particular lactobacilli and bifidobacteria improve immunity against infectious agents (Paubert-Braquet et al. Int J. Immunother. 11, 153-161 (1995)).

Known on the market is the existence of milk-based or milk-derived products that are supplemented with the addition of external substances. In particular in the dairy field, there are products derived from fermented milk, such as yoghurts, that are supplemented with the addition of a wide variety of foodstuffs selected from: minerals, vitamins, fruits and others. Therefore, the consumer could find products (beverage, milk product) containing supplemented vitamin C and it is still common to see nutritional labels food and beverage packages claiming to provide between 10% and 100% or more per serving of the daily value of vitamin C (60 mg). Unfortunately, most if not all of these foods don't have the amount of vitamin C above mentioned at the end of the shelf life. These products don't guarantee to the consumer, the minimum daily requirements of vitamin C during all the storage of the product, and in particular at the end of the shelf life of the product (at least 35 days).

Vitamin C (ascorbic acid) is a water soluble vitamin that must be provided in the human diet because it is not synthesized by the body. Vitamin C or L-ascorbic acid or L-ascorbate is an essential nutrient for humans and certain other animal species. It is physiologically required for synthesis of many essential tissues as well as biomolecules including neurotransmitters, fat transport molecules and for catabolism of a portion of the body's cholesterol. Vitamin C is also an effective antioxidant in vivo for protecting many proteins, fats, carbohydrates and nucleic acids from damaging reactive oxygen and free radical species. For all these reasons, it is important to have products which can provide a daily intake of vitamin C. In addition to its benefits as a nutritional value in food products, ascorbic acid is also used extensively in food industry for its many functional contributions to product quality. Acting as an antioxidant, ascorbic acid can improve the color and palatability of many kinds of food products. By removing oxygen from its surroundings ascorbic acid in its reduced form becomes the oxidized form, dehydroascorbic acid. This oxidizing action reduces the available oxygen in its immediate environment, making ascorbic acid an effective antioxidant.

If vitamin C is added as a nutrient to food product, the stability of the vitamin C over the shelf-life of the products becomes important. During the preservation, in particular storage and transportation of products with vitamin C, there is a strong loss of vitamin C. Oxygen is the most destructive ingredient causing degradation of vitamin C. Publication of Gliguem et al. (J. Dairy Sci. 88: 891-899, 2005) describe processing and storage factors affecting the stability of vitamin C and its levels persisting in milk. These include the sterilization process, extent of oxygen and light penetration of the packaging, and the duration of storage. In conclusion, only packaging comprising an oxygen and light barrier is compatible with vitamin C fortification of milk. Furthermore, short storage time or low storage temperature is needed to retard vitamin C degradation. There is a need for a dairy product having a low rate of loss of vitamin C during a long period of storage (at least 35 days), regardless the packaging used.

The problem of the oxidation of vitamin C during storage could be solved by adding a compensating concentration before the process, such that the recommended level is still present at the end of the shelf life. However, the degradation of high amounts of vitamin C in milk could have some deleterious effects on other aspects of the nutritional quality (Birlouez-Aragon et al. 2004).

Up to now, number efforts have been reported to slow the degradation of ascorbic acid. For examples: reducing the availability of oxygen, reducing the pH of the composition or adding oxygen scavengers. Several chemistries that might help stabilize vitamin C have also been investigated to some degree, including mixed phase emulsions and sacrificial phenolic antioxidants.

US2011/0217410 describes foods and beverages with vitamin C in a manner such that vitamin C dissolved in an aqueous solution or suspension is protected against oxidative degradation. This involves the joint inclusion of a dissolved water-soluble vitamin C and a water insoluble chemical derivative of vitamin C in the aqueous medium. The water insoluble chemical derivative of vitamin C is ascorbyl palmitate, in particular microparticulate form of ascorbyl palmitate. This document shows that the vitamin C can be stabilized against oxidation in an aqueous medium by adding water-insoluble microparticulate ascorbyl palmitate, where the microparticulate ascorbyl palmitate is maintained in a substantially undissolved state, as a suspension in the product. The product does not describe microparticles of vitamin C but particles of ascorbyl palmitate. Moreover, this document does not describe a milk composition, in particular a fermented milk composition with at least a Lactobacillus casei strain and a Streptococcus thermophilus strain.

KR20040048749 discloses iron fortified milk which contains vitamin C microencapsulated by polyglycerol monostearate, preventing oxidation of iron.

There is a need to make available a fermented dairy product providing the recommended daily allowances (RDA) of vitamin C at the end of the shelf life in particular at 35 days. Moreover, there is a need of a fermented dairy product in which the amount of viable lactic bacteria is maintained until the end of the shelf life. Typically, probiotics are live bacteria or active fractions thereof, that provide a health benefit to a host upon consumption. The inventors have surprisingly found that the Streptococcus thermophilus count decrease in contact with vitamin C. However, it is well known in the art that ascorbic acid tend to improve the viability of probiotic bacteria of the yogurt (Rajiv I. Dave et al. Int Dairy Journal 7 (1997) 435-443).

Hence, it is desirable to provide a fermented dairy product providing from 15% and 100% of RDA (Recommended dietary allowances) of oxidizable active, in particular vitamin C until the end of the shelf life of the product, having good organoleptic properties (no off-tastes, good mouth feel, no granular aspect in mouth . . . ) and containing a sufficient level of viable lactic bacteria.

The present invention addresses at least one of the problems or needs above mentioned with a fermented dairy product comprising microcapsules of oxidizable active, and a fermented milk composition.

The present invention particularly relates to a fermented dairy product comprising microcapsules of oxidizable active, and a fermented milk composition wherein the said fermented milk composition comprises at least a Streptococcus thermophilus strain.

The microcapsules according to the invention are microcapsules of oxidizable active comprise a core and a coating, said coating surrounding the core. The term “coating” used in the present invention means any layer (or coating layer) surrounding the core, once the encapsulating composition is applied and dried. In the present invention, the“core” comprises or consists in an oxidizable active.

In the present invention, the term “oxidizable” designates an agent which is able to become oxidized in contact with oxygen, in other words which is capable of undergoing a chemical reaction with oxygen. The term “active” “agent” “substance” can be used interchangeably.

In an advantageous embodiment, the oxidizable active is selected from the group comprising vitamin C, vitamin B5, vitamin B6, vitamin B8, vitamin B9, vitamin A, vitamin D3, vitamin K and vitamin E or a mixture thereof.

In another advantageous embodiment, the oxidizable active is vitamin C, in particular natural vitamin C or synthetic vitamin C. The term “synthetic vitamin C” used in the present invention designates salts of vitamin C. The term “natural vitamin C” designates fruit or vegetable preparation comprising vitamin C or a mixture of fruit and vegetable preparation comprising vitamin C, which is optionally dried.

In a particularly embodiment, the vitamin C is salts of L. ascorbic acid, in particular sodium L-ascorbate, calcium L-ascorbate and iron L-ascorbate

In another embodiment, the vitamin C is a fruit juice comprising vitamin C in particular acerola juice, camu camu juice, rosehip juice, goji berry juice, blackcurrants juice, kiwi juice, orange juice, cranberries juice, bananas juice, pears juice, pomegranate juice, apples juice, grapes juice and mixtures thereof. The fruit juice can be a liquid juice, a concentrated or dried juice. The fruit juice can also comprises additives like starch and its derivatives, pectin, agar agar, carraghenans, gums or polysaccharides.

In an advantageous embodiment, the coating comprises or consists in an encapsulating composition selected from the group comprising or consisting of alginate, salts of alginate, starch, modified starch, sources of celluloses, cellulose gum, maltodextrin, ascorbyl palmitate, sugars, gelatins, polysaccharides, proteins and mixtures thereof.

Preferably, in the present invention, the encapsulating composition comprises alginate and ascorbyl palmitate.

More preferably, in the present invention, characterized in that the encapsulating composition comprises at least a modified starch, alginate and cellulose gum, optionally in combination with maltodextrin.

In an advantageous embodiment, the microcapsules of oxidizable active have an average diameter lower than 200 in particular lower than 100 more particularly lower than 50 μm. The term <<average diameter>> refers to the volume medium diameter D (v;0.5) meaning that approximately 50 volume % of the microcapsules have an equivalent spherical diameter that is smaller than the average diameter and approximately 50 volume % of the microcapsules have an equivalent spherical diameter that is greater than the average diameter. Particularly, the fermented diary product according to the invention is characterized in that 90% of microcapsules have a diameter lower than 200 μm, more particularly 70% of microcapsules have a diameter between 80 and 150 μm and 30% of microcapsules have a diameter between 150 and 200 μm.

In an advantageous embodiment, the microcapsules of oxidizable active are in a fruit preparation or a technological mass. According to the invention, the term “fruit preparation” designates fruit juice or fruit puree with or without pieces of fruits as the same kind of fruit than the puree or different kind of fruit. The term “fruit puree” or “fruit compote” can be used interchangeably. The term “technological mass” used in the invention describes a liquid composition without fruits or fruit juices, such as water. The fruit preparation and the technological mass can comprise or contain stabilizers such as alginate, starch, modified starch, sources of celluloses, cellulose gum, maltodextrin, ascorbyl palmitate, sugars, gelatins, polysaccharides, proteins and mixtures thereof and/or one or more ingredients selected among vitamins and/or minerals, said vitamins or minerals are selected from the group consisting of beta-carotene, vitamin A, vitamin B1, vitamin B2, vitamin B6, vitamin B12, vitamin D3, vitamin E, calcium, magnesium, iron, iodine, copper, manganese, potassium, chromium, molybdenum, boron, betaine, glutamic acid.

In a particularly embodiment, the amount of oxidizable active, in particular vitamin C can represent between 15% and 150% of RDA (Recommended dietary allowances), more particularly between 30% and 80% of RDA, even more particularly between 40% and 70% of RDA.

In an advantageous embodiment, 100 g of said fermented dairy product comprises from 12 to 50 mg of vitamin C, in particular from 24 to 40 mg, more particularly from 30 to 35 mg of vitamin C, at the end of the shelf life, in particular up to 45 days, more particularly up to at 35 days. The product of the invention at the end of the process can contain for 100 g of said fermented dairy product, from 30 to 70 mg of vitamin C, in particular from 33 to 62 mg, of vitamin C.

In another embodiment, the rate of loss of vitamin C in said product is lower than 40%, in particular lower than 35%, even more particularly lower than 25%.

In a particularly embodiment, the fermented dairy product according to the invention comprises from 1.10⁵ to 1.10⁸ CFU/ml, more particularly from 8.10⁶ to 5.10⁷ CFU/ml of Streptococcus thermophilus strain, in particular at the end of the shelf life of the product. In a more preferred embodiment, Streptococcus thermophilus strain is selected among the strains which were deposited at the CNCM under the reference I-2773, I-2778 and I-2835.

In a particularly embodiment, the fermented dairy product according to the invention comprises from 1.10⁵ to 1.10⁹ CFU/ml of Lactobacillus casei strain. According to the invention, Lactobacillus casei strain is selected among the Lactobacillus casei ssp. paracasei strain or the Lactobacillus paracasei ssp. paracasei strain. The said Lactobacillus casei ssp. paracasei strain can be the strain which was deposited at the CNCM under the reference 1-1518.

The product of the invention can comprises at least Streptococcus thermophilus strain and/or at least Lactobacillus casei strain in the fermented milk composition.

The term “fermented milk composition” is a milk composition fermented with at least Streptococcus thermophilus strain and/or at least Lactobacillus casei strain. During the fermentation of the milk composition, the strains produce lactic acid and the number of lactic acid bacteria increases. Lactic acid bacteria and fermented products are well known by the one skilled in the art. The term “milk composition” according to the invention, means a milk product, a milk-based product or a milk-based food product. These compositions comprise milk or milk components, wherein the milk chemical composition is modified for example by fermentation. Herein a “milk based composition” encompassed “milk containing” composition. The milk and/or milk components are preferably cow milk. The fermented milk composition could be typically a fermented milk product or yogurt. The term “fermented milks” or “yogurts” have the usual meanings attributed to them in the dairy industry, i.e products which are intended for animal consumption, more particularly human consumption, and which are derived from acidifying lactic fermentation of a dairy substrate (animal milk, in particular cow milk). More particularly the denomination “fermented milk” (degree n. deg 88.-1203 of Dec. 30, 1988) is reserved for a dairy product prepared with skimmed milk or not, or condensed milks or powders some, having undergone a heat treatment at least equivalent to pasteurization, and sown with producing micro-organisms of lactic acid such as the lactobacilli (Lactobacillus acidophilus, L. casei, L. plantarum, L. reuteri, L. johnsonii), the certain streptococci (Streptococcus thermophilus), bifidobacteria and the lactococci ones. Moreover, the term “yogurt” is reserved for the fermented milk obtained, using standard methods, by the development of specific thermophilic lactic bacteria designated Lactobacillus bulgaricus (also designated Lactobacillus delbrueckii subsp. Bulgaricus) and Streptococcus thermophilus, which must be alive in the finished product, in an amount of at least 1.10⁷ CFU/ml of S. thermophilus and L. bulgaricus strain per gram of product.

In a particularly embodiment, the fermented milk composition comprises at least one bacteria selected from the genera Lactobacillus, Streptococcus, Lactococcus, and Bifidobacterium.

In a preferred embodiment, the fermented milk composition comprises Lactobacillus bulgaricus.

In another embodiment, the fermented dairy product according to the invention comprises one or more ingredients selected among vitamins and/or minerals, said vitamins being not encapsulated, said ingredients can be selected from the group consisting of beta-carotene, vitamin A, vitamin B1, vitamin B2, vitamin B6, vitamin B12, vitamin D3, vitamin E, calcium, magnesium, iron, iodine, copper, manganese, potassium, chromium, molybdenum, boron, betaine, glutamic acid.

In a preferred embodiment, the fermented dairy product comprises vitamin D3 and/or vitamin B6. Vitamin B6, or pyridoxine is a component of the vitamin B complex and plays several physiologic roles, in particular in formation and health of red blood cells and blood vessels, nerve function, teeth or in amino acid metabolism or antioxidant properties. Vitamin D3 or cholecalciferol is a component of the vitamin D complex.

In a preferred embodiment, 100 g of said fermented dairy product comprises from 0.5 to 15 μg of vitamin D3, in particular from 0.6 to 10 μg, more particularly from 0.7 to 4 μg of vitamin D3.

In more preferred embodiment of the present invention, 100 g of said fermented dairy product comprises 0.85 μg of vitamin D3. In a more advantageous embodiment, the amount of vitamin D3 can represent 15% or 20% or 25% or 50% or 70% or even 100% of RDA (Recomanded dietary allowances).

In a preferred embodiment, 100 g of said fermented dairy product comprises from 0.05 to 2.5 mg of vitamin B6, in particular from 0.08 to 2 mg, more particularly from 0.12 to 1.5 mg of vitamin B6. In an advantageous embodiment of the present invention, 100 g of said fermented dairy product comprises 0.15 mg of vitamin B6. In a more advantageous embodiment, the amount of vitamin B6 can represent 15% or 20% or 25% or 50% or 70% or even 100% of RDA (Recomanded dietary allowances).

In an advantageous embodiment, the fermented dairy product according to the invention comprises one or more additives selected from sweeteners, coloring agents, flavors, flavor enhancers, sugars, preservatives and combinations thereof.

In a preferred embodiment, the fermented dairy product according to the invention comprises:
from 0.005 to 5% of microcapsules of vitamin C by weight of product, in particular from 0.015 to 3.5%, more particularly from 0.2 to 2% of microcapsules of vitamin C by weight of product, and
from 1% to 99.95% of fermented milk composition by weight of product, in particular from 10 to 80%, more particularly from 50 to 70% of fermented milk composition by weight of product, wherein the said fermented milk composition comprises a least Lactobacillus casei strain and/or Streptococcus thermophilus strain.

In a more preferred embodiment, the fermented dairy product according to the invention comprises from 0.01 to 5%, in particular from 0.005 to 1% of microcapsules of vitamin C by weight of fruit preparation or of technological mass.

In another embodiment, the fermented dairy product according to the invention comprises from 5% to 90% of orange juice or technological mass comprising from 0.01% to 5% of microcapsules of vitamin C by weight of juice or technological mass.

The present invention also relates to a method comprising the step of dispersing of microcapsules of oxidizable active with a fermented milk composition.

In another embodiment of the present invention, the method comprises:
a) a step of fermentation of a milk composition with Lactobacillus casei and Streptococcus thermophilus to obtain a fermented milk composition, and
b) a step of mixing of the fermented milk composition obtained in step a) with at least 0.005 to 5% by weight of the product, of microcapsules of oxidizable active.

In another embodiment, in the step b) of the method the fermented milk composition obtained in step a) is mixed with microcapsules of vitamin C, in particular is mixed with a fruit preparation comprising microcapsules of vitamin C or a technological mass comprising microcapsules of vitamin C.

In a preferred embodiment, the method according to the invention wherein step b) comprises the following steps:
b1) preparing microcapsules of vitamin C,
b2) mixing microcapsules obtained in step b1) with a fruit preparation or a technological mass,
b3) pasteurizing at a temperature of at least 85° C. during 11 min,
b4) mixing the pasteurized composition of microcapsules of vitamin C obtained in step b3) in the fermented milk composition obtained in step a).

In a more preferred embodiment, in the method according to the invention, the step b) is necessary after the step a), more particularly after an optionally step of homogenization.

### FIGURES

This invention is illustrated by the following figures:

FIG. 1 represents an optical microscopy view of the microcapsules C in the fermented dairy product C.

FIG. 2 represents an optical microscopy view of the microcapsules A in the fermented dairy product A.

FIG. 3 shows the vitamin C relative stability (%) of microcapsules C in the fermented dairy product C.

Further details or advantages of the invention might appear in the following non limitative examples.

### EXAMPLES

### Example 1

### Preparation of the Product According to the Invention

1) Preparation of Microcapsules
Microcapsules of vitamin C were prepared by a step of spraying on particles consisting in vitamin C (sodium ascorbate), or particles comprising vitamin C (acerola juice), with the encapsulating compositions below mentioned. Then the microcapsules are dried to obtain dried microcapsules.
3 kinds of microcapsules of vitamin C were prepared either from acerola juice (Table 1) or from sodium ascorbate (Table 2)
   Ex:

TABLE 1
microcapsules of natural vitamin C

| Ingredients: Microcapsules A | g/100 g of dried capsule |
|---|---|
| Acerola juice | 60-65 |
| Modified starch | 20-30 |
| Maltodextrin | 5-20 |
| Alginate | 3-10 |
| Cellulose gum | 1-5 |

TABLE 2
microcapsules of synthetic vitamin C with 2 different encapsulating
compositions

| | g/100 g of dried capsule |
|---|---|
| Ingredients: Microcapsules B | |
| Sodium ascorbate | 60-65 |
| Modified amidon | 25-33 |
| Alginate | 5-10 |
| Cellulose gum | 1-5 |
| Ingredients: Microcapsules C | |
| Sodium ascorbate | 90-97 |
| Alginate | 3-10 |
| Ascorbyl palmitate | 0.2-1 |

2) Preparation of a Fermented Milk Composition
Milk fermented with Lactobacillus casei strain and Streptococcus thermophilus strains was prepared. The Lactobacillus casei used is Lactobacillus casei CNCM I-1518. The Streptococcus thermophilus used are CNCM I-2773, CNCM I-2835, CNCM I-2778. The fermentation step is well known by the one skilled in the art. The preparation of the fermented milk composition is standard for the other steps of preparation.

3) Preparation of Fermented Dairy Products A, B and C According to the Invention, Comprising Microcapsules A, B and C

Microcapsules A, B and C are prepared and mixed in a fruit preparation, in particular orange juice. The orange juice with microcapsules is pasteurized at a temperature of at least 85° C. during 11 min, then the juice is cooled and storage in cool conditions before the mixing step. Then, 12% orange juice is added in a fermented milk composition.

### Example 2

### Analysis of Vitamin C Microcapsules in Optical Microscopy in the Fermented Dairy Products A and C

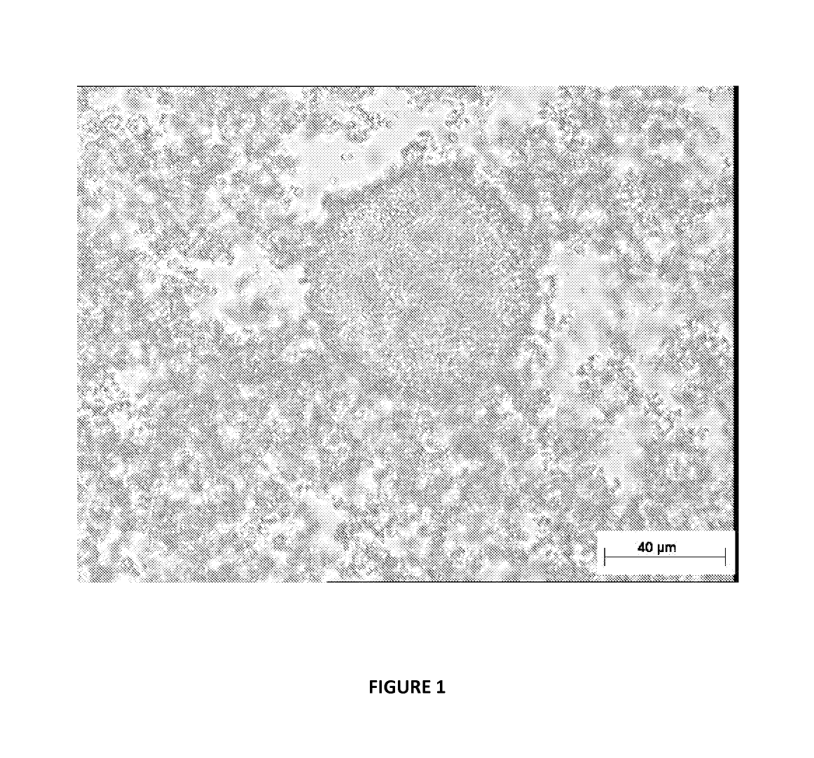

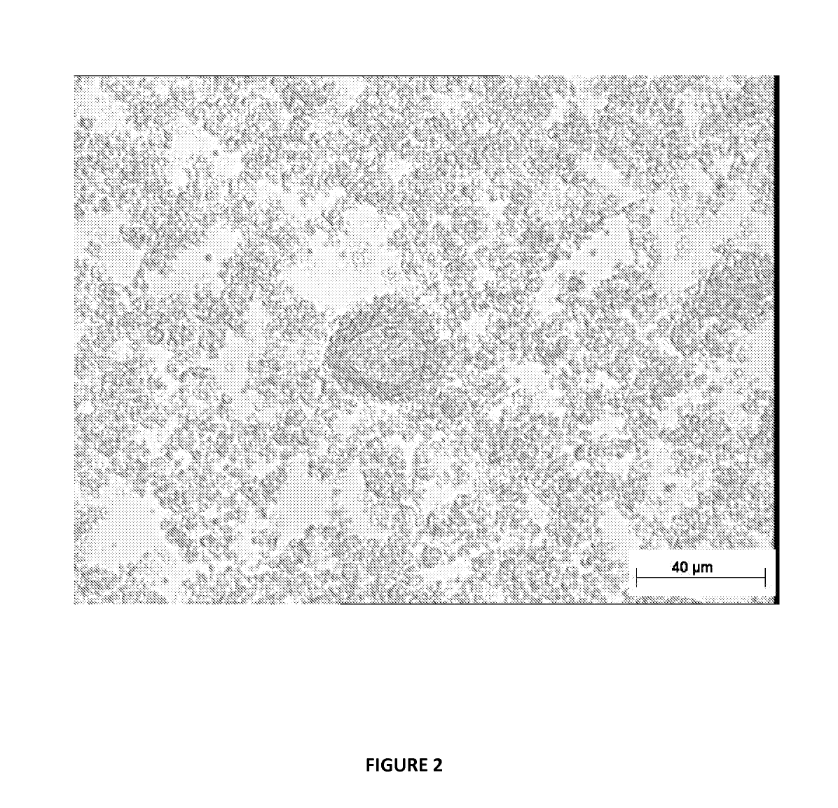

FIGS. 1 and 2 represent an optical microscopy view of the microcapsules C and A in the fermented dairy product C and A.

From the FIGS. 1 and 2, it can be observed that the coating according to the invention surrounding regularly the core ensuring a good stability of the vitamin C during the time and a good protection of the elements of the fermented milk composition in contact with these microcapsules.

These characteristics allow a long packaging time of the fermented dairy products A and C without significant degradation of its qualities, in particular organoleptic qualities.

### Example 3

### Study of the Stability of Vitamin C Microcapsules A, B and C Until the End of the Shelf Life

a) Study of the Stability of Vitamin C Microcapsules A, B and C Until the End of the Shelf Life

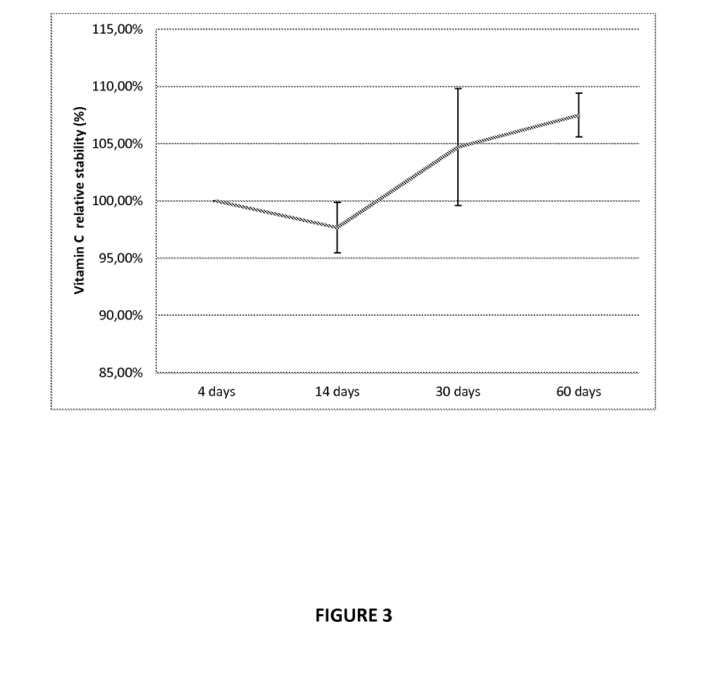

Stability of microcapsule C was analyzed during the storage of microcapsules up to 60 days. FIG. 3 shows that during the storage time, microcapsules have a good stability when suspended in a dairy product (HPLC method standard deviation: ±10%; NF-V0135).

b) Study of the Stability of Vitamin C Microcapsules A, B and C in the Fermented Dairy Products A, B and C Until the End of the Shelf Life

The stability is determined by the measurement of the rate of vitamin C for each of the products A, B and C, the day of the production (D3) and 35 days after (D35), using the High Performance Liquid Chromatography. The rate of loss of vitamin C corresponds to the report of the amount of vitamin C at D35 versus the amount of vitamin C at D3.

Stability of microcapsules A, B and C was analyzed in fermented dairy products A, B and C Microcapsules of synthetic vitamin C (microcapsules B and C) or of natural vitamin C (microcapsule A) were incorporated in the dairy products as of 80% RDA¹ or 30% RDA respectively. Results are the expression of at least three experiments.

i) Evaluation of the Stability of the Synthetic Vitamin C Microencapsulated and Vitamin C Non Encapsulated (Control)

| | microcapsule C | microcapsule B | non encapsulated |
|---|---|---|---|
| vitamin C D35/D3² | 73.18* | 59.12* | 27.53 |
| (% of relative | | | |
| stability) | | | |
| Standard deviation | 11.27 | 13.36 | 11.88 |

¹RDA: EU 100% RDA is 80 mg;
²vitamin C was analyzed using HPLC method at D3 and D35
*significant versus control (no capsules)

At 80% RDA, results demonstrated that microcapsules C and B ensure significant synthetic vitamin C stability when compared to the control

i) Evaluation of the Stability of the Natural Vitamin C Microencapsulated and Vitamin C Non Encapsulated (Control)

| | Microcapsules A | non encapsulated |
|---|---|---|
| vitamin C D35/D3² | 67.15* | 20.21 |
| (% of relative stability) | | |
| Standard deviation | 6.5 | 3.4 |

¹RDA: EU 100% RDA is 80 mg ;
²vitamin C was analyzed using HPLC method at D3 and D35;
*significant versus control (no capsules)

At 30% RDA, results demonstrated that microcapsules A ensure a significant synthetic vitamin C stability when compared to the control

### Example 4

### Study of the Impact of the Vitamin C on the Count of Streptococcus thermophilus in Fermented Dairy Products According to the Invention

Microcapsules of synthetic (C and D) or natural vitamin C (A) were incorporated in the dairy products as of 80% RDA¹ or 30% RDA respectively. Streptococcus thermophilus counts were analyzed at D4, D14 and D35. Results are the expression of at least three experiments.

ii) Evaluation of the Streptococcus thermophilus Counts Stability During the Product Shelf-Life (35 Days) when Using Microcapsules of Synthetic Vitamin C (C and D) and Vitamin C Non Encapsulated (Control)

| Cfu/ | | | |
|---|---|---|---|
| ml of product | Microcapsules C | Microcapsules D | non encapsulated |
| D4 | 5.28E+08 | 5.40E+08 | 4.50E+08 |
| D14 | 1.98E+08 | 2.10E+08 | 1.46E+08 |
| D35 | 7.96E+07* | 9.24E+07* | 3.22E+05 |

*significant versus control (no capsules)

At 80% RDA, results demonstrated a significant stability of the Streptococcus thermophilus counts at the end of the shelf-life (35 days) when using microcapsules of synthetic vitamin C (microcapsules and D) compared to the control

ii) Evaluation of the Streptococcus thermophilus Counts Stability During the Product Shelf-Life (35 Days) when Using Microcapsules of Natural Vitamin C (Microcapsule A) and Vitamin C Non Encapsulated (Control)

| Cfu/ml of product | Microcapsules A | non encapsulated |
|---|---|---|
| D4 | 2.81E+08 | 3.93E+08 |
| D14 | 8.78E+07 | 3.61E+07 |
| D35 | 1.34E+07 | <E+05 |

*significant versus control (no capsules)

At 30% RDA, results demonstrated a significant stability of the Streptococcus thermophilus counts at the end of the shelf-life (35 days) when using microcapsules of synthetic vitamin C (microcapsule A) compared to control.

1. A fermented dairy product comprising
microcapsules of oxidizable active, and
a fermented milk composition.

2. The fermented dairy product according to claim 1 wherein the fermented milk composition comprises at least a Streptococcus thermophilus strain.

3. The fermented dairy product according to claim 1, wherein the oxidizable active is selected from the group consisting of vitamin C, vitamin B5, vitamin B6, vitamin B8, vitamin B9, vitamin A, vitamin D3, vitamin K and vitamin E and a mixture thereof.

4. The fermented dairy product according to claim 3, wherein vitamin C comprises salts of L. ascorbic acid.

5. The fermented dairy product according to claim 3, wherein the vitamin C is a fruit preparation comprising vitamin C.

6. The fermented dairy product according to claim 5, wherein the fruit preparation is a liquid juice or a concentrated or dried juice.

7. The fermented dairy product according to claim 1, comprising a coating, wherein the coating comprises an encapsulating composition selected from the group consisting of alginate, starch, modified starch, sources of celluloses, cellulose gum, maltodextrin, ascorbyl palmitate, sugars, gelatins, polysaccharides, proteins and mixtures thereof.

8. The fermented dairy product according to claim 7, wherein the encapsulating composition comprises alginate and ascorbyl palmitate.

9. The fermented dairy product according to claim 7, wherein the encapsulating composition comprises at least a modified starch, alginate and cellulose gum, optionally in combination with maltodextrin.

10. The fermented dairy product according to claim 1, wherein the microcapsules of oxidizable active have an average diameter lower than 200 μm.

11. The fermented dairy product according to claim 1, wherein the microcapsules of oxidizable active are in a fruit preparation or a technological mass.

12. The fermented dairy product according to claim 1, wherein 100 g of the fermented dairy product comprises from 12 to 50 mg of vitamin C at the end of a shelf life.

13. The fermented dairy product according to claim 3, wherein a rate of loss of vitamin C in the product is lower than 40%.

14. The fermented dairy product according to claim 1, wherein the product comprises from 1.10⁵ to 1.10⁸ CFU/ml of Streptococcus thermophilus.

15. The fermented dairy product according to claim 1 comprising:
from 0.005 to 5% of microcapsules of vitamin C by weight of product, and
from 1% to 99.95% of fermented milk composition by weight of product.

16. The fermented dairy product according to claim 1 comprising from 5% to 90% of orange juice comprising from 0.01% to 5% of microcapsules of vitamin C by weight of juice.

17. A method for preparing a fermented dairy product according to claim 1, the method comprising dispersing microcapsules of oxidizable active with the fermented milk composition.

18. The method according to claim 17, comprising:
a) fermenting a milk composition with Lactobacillus casei and Streptococcus thermophilus to obtain the fermented milk composition, and
b) mixing the fermented milk composition obtained in step a) with at least 0.005 to 5% by weight of the product, of microcapsules of oxidizable active.

19. The method according to claim 18, wherein in step b) the fermented milk composition obtained in step a) is mixed with microcapsules of vitamin C.

20. The method according to claim 1, wherein in step b) the fermented milk composition obtained in step a) is mixed with a fruit preparation comprising microcapsules of vitamin C.

21. The method for preparing a fermented dairy product according to claim 18, wherein step b) comprises the following steps:
b1) preparing microcapsules of vitamin C,
b2) mixing microcapsules obtained in step b1) with a fruit preparation or a technological mass,
b3) pasteurizing at a temperature of at least 85° C. during 11 min,
b4) mixing the pasteurized composition of microcapsules of vitamin C obtained in step b3) in the fermented milk composition obtained in step a).

22. The method for preparing a fermented dairy product according to claim 18, wherein the step b) is necessary after the step a), and is after an optional step of homogenization.

23. The fermented dairy product according to claim 4, wherein the salts of L. ascorbic acid comprises one or more of sodium L-ascorbate, calcium L-ascorbate and iron L-ascorbate.

24. The fermented dairy product according to claim 5, wherein the fruit preparation comprises one or more of acerola juice, camu camu juice, rosehip juice, goji berry juice, blackcurrants juice, kiwi juice, orange juice, cranberries juice, bananas juice, pears juice, pomegranate juice, apples juice, grapes juice and mixtures thereof.
